(19) United States
(12) Patent Application Publication
(10) Pub. No.: US 2010/0004409 A1
(43) Pub. Date: Jan. 7, 2010

(54) METHOD FOR PRODUCING POLYOXYMETHYLENES WITH CERTAIN DEACTIVATORS

(75) Inventors: Claudius Schwittay, Antwerp (BE); Bernd Bruchmann, Freinsheim (DE); Jens Assmann, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/374,853

(22) PCT Filed: Jul. 17, 2007
(86) PCT No.: PCT/EP2007/057349

§ 371 Date: Jan. 23, 2009

(30) Foreign Application Priority Data
Jul. 26, 2006 (EP) 06117857.0

(51) Int. Cl. C08F 2/40

(52) U.S. Cl. 526/71

(57) ABSTRACT

A process for the preparation of polyoxymethylene homo- or copolymers (POM) by polymerization of suitable monomers and subsequent deactivation by addition of a deactivator, wherein the deactivator used is a highly branched or hyperbranched polymer A) which is selected from highly branched or hyperbranched polycarbonates A1) and highly branched or hyperbranched polyesters A2), the polymer A) comprising nitrogen atoms.

The invention relates to a process for the preparation of polyoxymethylene homo- or copolymers (POM) by polymerization of suitable monomers and subsequent deactivation by addition of a deactivator, wherein the deactivator used is a highly branched or hyperbranched polymer A) which is selected from highly branched or hyperbranched polycarbonates A1) and highly branched or hyperbranched polyesters A2), the polymer A) comprising nitrogen atoms.

The invention also relates to the polyoxymethylene homo- or copolymers (POM) obtainable by this process; and the use of the highly branched or hyperbranched polycarbonates A1) comprising nitrogen atoms in the preparation of polyoxymethylene homo- or copolymers (POM); and the use of the highly branched or hyperbranched polyesters A2) comprising nitrogen atoms in the preparation of polyoxymethylene homo- or copolymers (POM).

Finally, the invention relates to a deactivator for deactivating the polymerization in the preparation of polyoxymethylene homo- or copolymers (POM), comprising a highly branched or hyperbranched polymer A) which is selected from highly branched or hyperbranched polycarbonates A1) and highly branched or hyperbranched polyesters A2), the polymer A) comprising nitrogen atoms.

Polyoxymethylene homo- or copolymers (POM, also referred to as polyacetals) are obtained by polymerization of formaldehyde, 1,3,5-trioxane (trioxane for short) or another formaldehyde source, comonomers such as 1,3-dioxolane, 1,3-butanediol formal or ethylene oxide being concomitantly used for the preparation of copolymers. The polymers are known and are distinguished by a number of excellent properties so that they are suitable for a very wide range of technical applications.

Polymerization is usually carried out cationically; for this purpose, strong protic acids, for example perchloric acid, or Lewis acids, such as tin tetrachloride or boron trifluoride, are metered as initiators (catalysts) into the reactor. The polymerization can advantageously be carried out in the melt, cf. for example EP 80656 A1, EP 638 357 A2, EP 638 599 A2 and WO 2006/058679 A.

The reaction is usually then stopped by metering in basic deactivators. The deactivators used to date are basic organic or inorganic compounds. The organic deactivators are monomeric compounds, for example amines, such as triethylamine or triacetonediamine, alkali metal or alkaline earth metal salts of carboxylic acids, for example sodium acetate, alkali metal or alkaline earth metal alcoholates, such as sodium methanolate, or alkali metal or alkaline earth metal alkyls, such as n-butyllithium. The boiling point or decomposition point of these organic compounds is usually below 170° C. (at 1013 mbar). Suitable inorganic deactivators are, inter alia, ammonia, basic salts, such as alkali metal or alkaline earth metal carbonates, e.g. sodium carbonate, or hydroxides, and borax, which are usually used as a solution. As a rule, water or alcohols are used as solvents. However, these are not inert under the conditions of the POM preparation, which leads to undesired polymer degradation reactions.

The conversion in the polymerization is usually not complete; rather, crude POM polymer still comprises up to 40% of unconverted monomers. Such residual monomers are, for example, trioxane, tetroxane and formaldehyde and any concomitantly used comonomers, such as 1,3-dioxolane, 1,3-butanediol formal or ethylene oxide. The residual monomers are separated off in a devolatilization apparatus. It would be economically advantageous to recycle them directly to the polymerization.

However, the residual monomers separated off are often contaminated with the deactivators, and recycling of these deactivator-containing residual monomers to the reactor adversely affects the product properties and slows down the polymerization or brings it completely to a stop. Owing to the stated high boiling or decomposition point of the organic deactivators, they cannot as a rule be separated off by simple distillation.

The non-prior-published German patent application no. 102005027802.7 of Jun. 15, 2005 therefore proposes, as a remedy, freeing the monomers from the deactivators in a purification step by bringing into contact with certain solids (silica gels, molecular sieves, alumina or other Lewis acid compounds).

The non-prior-published German patent application no. 102005022364.8 of May 10, 2005 discloses the use of hyperbranched polyethylenimines for reducing the residual formaldehyde content in POM. Hyperbranched polycarbonates or polyesters or a use as a deactivator are not mentioned.

It was the object to remedy the disadvantages described. It was intended to find a process for POM preparation in which the deactivation is effected in a simple manner and requires no subsequent measures, such as, for example, purification of the recycled residual monomers, which adversely affect the cost-efficiency of the overall process.

The process should make it possible to meter in the deactivator in a simple manner, preferably in liquid form or dissolved in those solvents which do not interfere with the polymerization and by means of which the recycling of the residual monomers into the polymerization is not impaired.

Moreover, it should be possible to recycle the residual monomers to the process in a simple manner, in particular without intermediate purification steps.

Finally, the deactivator compound should be effective even in small amounts and should bring the polymerization reaction rapidly and reliably to a stop.

Accordingly, the process defined at the outset for POM preparation and the polyoxymethylene homo- or copolymers obtainable therewith were found. In addition, the use of the highly branched or hyperbranched polycarbonates or polyesters in the POM preparation, and the deactivator mentioned, were found. Preferred embodiments of the invention are described in the subclaims. All pressure data are absolute pressures.

Polyoxymethylene Homo- or Copolymers

The polyoxymethylene homo- or copolymers (POM) are known as such and are commercially available. The homopolymers are prepared by polymerization of formaldehyde or—preferably—trioxane; in the preparation of the copolymers, comonomers are moreover concomitantly used. The monomers are preferably selected from formaldehyde, trioxane and other cyclic or linear formals or other formaldehyde sources.

Very generally, such POM polymers have at least 50 mol % of repeating units —CH₂O— in the polymer main chain. Polyoxymethylene copolymers are preferred, in particular those which, in addition to the repeating units —CH₂O—, also comprise up to 50, preferably from 0.01 to 20, in particular from 0.1 to 10, mol % and very particularly preferably from 0.5 to 6 mol % of repeating units

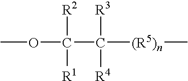

where R¹ to R⁴, independently of one another, are a hydrogen atom, a C₁- to C₄-alkyl group or a halogen-substituted alkyl group having 1 to 4 carbon atoms and R⁵ is —CH₂—, —CH₂O—, a C₁- to C₄-alkyl- or C₁- to C₄-haloalkyl-substituted methylene group or a corresponding oxymethylene group and n has a value in the range of from 0 to 3. Advantageously, these groups can be introduced into the copolymers by ring opening of cyclic ethers. Preferred cyclic ethers are those of the formula

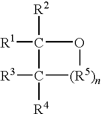

where R¹ to R⁵ and n have the abovementioned meaning. Merely by way of example, ethylene oxide, 1,2-propylene oxide, 1,2-butylene oxide, 1,3-butylene oxide, 1,3-dioxane, 1,3-dioxolane and 1,3-dioxepane (=butanediol formal, BUFO) may be mentioned as cyclic ethers and linear oligoformals or polyformals, such as polydioxolane or polydioxepane, may be mentioned as comonomers.

Also suitable are oxymethylene terpolymers, which are prepared, for example, by reacting trioxane and one of the cyclic ethers described above with a third monomer, preferably bifunctional compounds of the formula

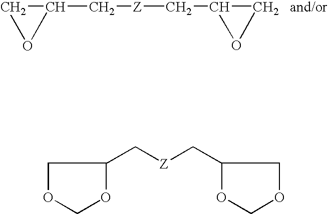

where Z is a chemical bond, —O—, —ORO— (R is C₁- to C₈-alkylene or C₃- to C₈-cycloalkylene).

Preferred monomers of this type are ethylene diglycide, diglycidyl ether and diethers of glycidyls and formaldehyde, dioxane or trioxane in the molar ratio 2:1 and diethers of 2 mol of glycidyl compound and 1 mol of an aliphatic diol having 2 to 8 carbon atoms, such as, for example, the diglycidyl ethers of ethylene glycol, 1,4-butanediol, 1,3-butanediol, cyclobutane-1,3-diol, 1,2-propanediol and cyclohexane-1,4-diol, to mention but a few examples.

End group-stabilized polyoxymethylene polymers which have predominantly C—C— or —O—CH₃ bonds at the chain ends are particularly preferred.

The preferred polyoxymethylene copolymers have melting points of at least 150° C. and molecular weights (weight average) M_{w} in the range from 5000 to 300 000, preferably from 7000 to 250 000. Particularly preferred are POM copolymers having a nonuniformity (M_{w}/Mₙ) of from 2 to 15, preferably from 2.5 to 12, particularly preferably from 3 to 9. The measurements are effected, as a rule, by gel permeation chromatography (GPC)/SEC (size exclusion chromatography), and the Mₙ value (number average molecular weight) is generally determined by means of GPC/SEC.

The molecular weights of the polymer can, if appropriate, be adjusted to the desired values by means of the regulators customary in trioxane polymerization and by means of the reaction temperature and residence time in the reaction. Suitable regulators are acetals or formals of monohydric alcohols, the alcohols themselves and the small amounts of water which act as chain-transfer agents and whose presence can as a rule never be completely avoided. The regulators are used in amounts of from 10 to 10 000, preferably from 20 to 5000, ppmw (parts per million by weight), based on the monomers.

In the case of formaldehyde as a monomer, the polymerization can be initiated anionically or cationically; in the case of trioxane as a monomer, it can be initiated cationically. Preferably, the polymerization is initiated cationically.

The cationic initiators customary in trioxane polymerization are used as initiators (also referred to as catalysts). Protic acids, such as fluorinated or chlorinated alkane- and arylsulfonic acids, e.g. perchloric acid, or trifluoromethanesulfonic acid, or Lewis acids, such as, for example, tin tetrachloride, arsenic pentafluoride, phosphorous pentafluoride and boron trifluoride, and the complex compounds thereof and salt-like compounds, e.g. boron trifluoride etherate and triphenylmethylene hexafluorophosphate, are suitable. The initiators (catalysts) are used in amounts of from about 0.01 to 1000, preferably from 0.01 to 500 and in particular from 0.01 to 200 ppmw, based on the monomers.

In general, it is advisable to add the initiator in dilute form, preferably as a solution or dispersion having concentrations of from 0.005 to 5% by weight. Inert compounds, such as aliphatic or cycloaliphatic hydrocarbons, e.g. cyclohexane, halogenated aliphatic hydrocarbons, glycol ethers, cyclic carbonates, lactones, etc., can be used as solvents or dispersants for this purpose. Particularly preferred solvents are triglyme (triethylene glycol dimethyl ether), 1,4-dioxane, propylene carbonate or gamma-butyrolactone.

In addition to the initiators, co-catalysts may be concomitantly used. These are alcohols of any type, for example aliphatic alcohols having 2 to 20 carbon atoms, such as tert-amyl alcohol, methanol, ethanol, propanol, butanol, pentanol or hexanol; aromatic alcohols having 6 to 30 carbon atoms, such as hydroquinone; halogenated alcohols having 2 to 20 carbon atoms, such as hexafluoroisopropanol; glycols of any type are very particularly preferred, in particular diethylene glycol and triethylene glycol; and aliphatic dihydroxy compounds, in particular diols having 2 to 6 carbon atoms, such as 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol.

Monomers, initiators, co-catalysts and, if appropriate, regulators can be added to the polymerization reaction in any desired manner in premixed form or separately from one another.

Furthermore, the components for stabilization may comprise sterically hindered phenols, as described in EP-A 129369 or EP-A 128739.

The polymerization mixture is preferably deactivated directly after the polymerization, preferably without a phase change taking place. The deactivation of the initiator residues (catalyst residues) is effected as a rule by adding deactivators (chain-terminating agents) to the polymerization melt. Deactivators suitable according to the invention are described further below.

POM from formaldehyde can be prepared in a customary manner by polymerization in the gas phase or in solution, by precipitation polymerization or by mass polymerization. POM from trioxane are obtained as a rule by mass polymerization, it being possible to use for this purpose any reactors having a good mixing effect. The reaction can be carried out homogeneously, for example in a melt, or heterogeneously, for example as polymerization to give a solid or solid granules. For example, shell reactors, plowshare mixers, tubular reactors, List reactors, kneaders (e.g. Buss kneaders), extruders having, for example, one or two screws and stirred reactors are suitable, it being possible for the reactors to have static or dynamic mixers.

In a mass polymerization, for example in an extruder, a so-called melt seal toward the extruder feed can be produced by molten polymer, with the result that volatile constituents remain in the extruder. The above monomers are metered into the polymer melt present in the extruder, together with or separately from the initiators (catalysts), at a preferred temperature of the reaction mixture of from 62 to 114° C. The monomers (trioxane), too, are preferably metered in the molten state, for example at from 60 to 120° C.

The melt polymerization is effected as a rule at from 1.5 to 500 bar and from 130 to 300° C., and the residence time of the polymer mixture in the reactor is usually from 0.1 to 20, preferably from 0.4 to 5, min. The polymerization is preferably carried out to a conversion of more than 30%, e.g. from 60 to 90%.

In each case, a crude POM which, as mentioned, comprises considerable proportions, for example up to 40%, of unconverted residual monomers, in particular trioxane and formaldehyde, is obtained. Formaldehyde may be present in the crude POM even when only trioxane was used as a monomer, since it can form as a degradation product of trioxane. Moreover, other oligomers of formaldehyde may also be present, for example the tetramer tetroxane.

Trioxane is preferably used as a monomer for the preparation of POM, and it is for this reason that the residual monomers also comprise trioxane, and additionally usually from 0.5 to 10% by weight of tetroxane and from 0.1 to 75% byweight of formaldehyde.

The crude POM is usually devolatilized in a devolatilization apparatus. Suitable devolatilization apparatuses are flash pots, vented extruders having one or more screws, filmtruders, thin-film evaporators, spray dryers, falling strand devolatilizers and other customary devolatilization apparatuses. Vented extruders or flash pots are preferably used. The latter are particularly preferred.

The devolatilization can be effected in one stage (in a single devolatilization apparatus). It may also be effected in a plurality of stages—for example in two stages—in a plurality of devolatilization apparatuses identical or different in type and size. Two different flash pots in series are preferably used, it being possible for the second pot to have a smaller volume.

In a one-stage devolatilization, the pressure in the devolatilization apparatus is usually from 0.1 mbar to 10 bar, preferably from 5 mbar to 800 mbar, and the temperature is as a rule from 100 to 260, in particular from 150 to 210, ° C. In a two-stage devolatilization, the pressure in the first stage is preferably from 0.1 mbar to 10 bar, preferably from 1 mbar to 7 bar, and that in the second stage is preferably from 0.1 mbar to 5 bar, preferably from 1 mbar to 1.5 bar. In a two-stage devolatilization, the temperature does not as a rule differ substantially from the temperatures mentioned for the one-stage devolatilization.

The heating of the polymer during the devolatilization is effected in a customary manner by heat exchangers, double jackets, thermostatted static mixers, internal heat exchangers or other suitable apparatuses. The devolatilization pressure is likewise established in a manner known per se, for example by means of pressure control valves. The polymer may be present in the devolatilization apparatus in molten or solid form.

The residence time of the polymer in the devolatilization apparatus is as a rule from 0.1 sec to 30 min, preferably from 0.1 sec to 20 min. In a multistage devolatilization, these times are based in each case on a single stage.

The devolatilized polymer is taken off from the devolatilization apparatus as a rule by means of pumps, extruders or other customary transport members.

The residual monomers liberated during the devolatilization are separated off in the vapor stream. Independently of the form of the devolatilization (one-stage or multistage, flash pots or vented extruders, etc.) the residual monomers are usually selected from trioxane, formaldehyde, tetroxane, 1,3-dioxolane, 1,3-dioxepane, ethylene oxide and oligomers of formaldehyde.

The residual monomers separated off (vapor stream) are taken off in a customary manner. They may be condensed and recycled to the polymerization. The ratio of trioxane and formaldehyde in the vapor stream can be varied by establishing appropriate pressures and temperatures.

The devolatilized polymers, i.e. the polyoxymethylene homo- and copolymers obtainable by the process according to the invention, can be provided with customary additives. Such additives are, for example,
talc,
polyamides, in particular copolyamides,
alkaline earth metal silicates and alkaline earth metal glycerophosphates,
esters or amides of saturated aliphatic carboxylic acids,
ethers which are derived from alcohols and ethylene oxide,
nonpolar polypropylene waxes,
nucleating agents,
fillers,
impact-modifying polymers, in particular those based on ethylene-propylene (EPM) or ethylene-propylene-diene (EPDM) rubbers,
flameproofing agents,
plasticizers,
adhesion promoters,
dyes and pigments,
formaldehyde scavengers, in particular amine-substituted triazine compounds, zeolites or polyethylenimines,
antioxidants, in particular those having a phenolic structure, benzophenone derivatives, benzotriazole derivatives, acrylates, benzoates, oxanilides and sterically hindered amines (HALS=hindered amine light stabilizers).

The additives are known and are described, for example, in Gachter/Müller, Plastics Additives Handbook, Hanser Verlag Munich, 4th edition 1993, reprint 1996.

The amount of the additives depends on the additive used and on the desired effect. The customary amounts are known to the person skilled in the art. If concomitantly used, the additives are added in a customary manner, for example individually or together, as such, as a solution or suspension or preferably as masterbatch.

The complete POM molding material can be prepared in a single step by, for example, mixing the POM and the additives in an extruder, kneader or mixer or another suitable mixing apparatus with melting of the POM, discharging the mixture and then granulating it in a customary manner.

However, it has proven advantageous first to premix some or all of the components in a dry blender or another mixing apparatus at room temperature and to homogenize the resulting mixture in a second step with melting of the POM—if appropriate with addition of further components—in an extruder or other mixing apparatus. In particular, it may be advantageous to premix at least the POM and the antioxidant (if concomitantly used).

The mixing apparatus, e.g. the extruder, can be provided with devolatilization apparatuses, for example for removing residual monomers or other volatile constituents in a simple manner. The homogenized mixture is discharged as usual and preferably granulated.

In order to minimize the residence time of the devolatilized POM between devolatilization apparatus and mixing apparatus, the (only or last) devolatilization apparatus can be mounted directly on a mixing apparatus. Particularly preferably, the discharge from the devolatilization apparatus coincides with the entry into the mixing apparatus. For example, it is possible to use a flash pot which has no base and which is mounted directly on the feed dome of an extruder. As a result, the extruder is the base of the flash pot and is simultaneously the discharge apparatus thereof.

Highly Branched or Hyperbranched Polycarbonates A1) or Polyesters A2)

According to the invention, a highly branched or hyperbranched polymer A) which is selected from highly branched or hyperbranched polycarbonates A1) and highly branched or hyperbranched polyesters A2) is used as a deactivator. A common feature of the polycarbonates A1) and the polyesters A2) is accordingly their highly branched or hyperbranched structure.

According to the invention, the polymer A), i.e. the highly branched or hyperbranched polycarbonates A1) or polyesters A2), comprises nitrogen atoms.

Below, the polycarbonates A1) and the polyesters A2) are described first. Their functionalization with nitrogen atoms is described thereafter.

Preferably, the highly branched or hyperbranched polycarbonate A1) has an OH number of from 0 to 600, preferably from 0 to 550 and in particular from 5 to 550 mg KOH/g of polycarbonate (according to DIN 53240, part 2).

In the context of this invention, hyperbranched polycarbonates A1) are understood as meaning uncrosslinked macromolecules having hydroxyl and carbonate groups, which have both structural and molecular non-uniformity. They can on the one hand have a composition starting from a central molecule analogously to dendrimers but with a non-uniform chain length of the branches. They can on the other hand also have a linear composition with functional side groups or have linear and branched molecular moieties as a combination of the two extremes. For a definition of dendrimeric and hyperbranched polymers, also see P. J. Flory, J. Am. Chem. Soc. 1952, 74, 2718 and H. Frey et al., Chem. Eur. J. 2000, 6, No. 14, 2499.

In relation to the present invention, “hyperbranched” is understood as meaning that the degree of branching (DB), i.e. the average number of dendritic linkages plus the average number of end groups per molecule, is from 10 to 99.9%, preferably from 20 to 99%, particularly preferably from 20 to 95%.

In relation to the present invention, “dendrimeric” is understood as meaning that the degree of branching is from 99.9 to 100%. For a definition of the “degree of branching”, cf. H. Frey et al., Acta Polym. 1997, 48, 30.

The degree of branching DB of the relevant substances is defined as

$$DB = \frac{T + Z}{T + Z + L} \times 100 \% ,$$

where T is the average number of terminal monomer units, Z is the average number of branched monomer units and L is the average number of linear monomer units in the macromolecules of the respective substances.

Preferably, the component A1) has a number average molecular weight Mₙ of from 100 to 15 000, preferably from 200 to 12 000 and in particular from 500 to 10 000 g/mol, determinable, for example, by GPC using polymethyl methacrylate (PMMA) as a standard and dimethylacetamide as a mobile phase.

The glass transition temperature T_{g} is in particular from −80° C. to +140° C., preferably from −60 to 120° C., determined by means of differential scanning calorimetry (DSC) according to DIN 53765.

In particular, the viscosity at 23° C. is from 50 to 200 000, in particular from 100 to 150 000 and very particularly preferably from 200 to 100 000 mPa·s according to DIN 53019.

The component A1) is preferably obtainable by a process which at least comprises the following steps:
aa) reaction of at least one organic carbonate I) of the general formula RO[(CO)]ₙOR with at least one aliphatic, aliphatic-aromatic or aromatic alcohol II) which has at least 3 OH groups, with elimination of alcohols ROH to give one or more condensates K), R in each case independently of one another being a straight-chain or branched aliphatic, aromatic/aliphatic or aromatic hydrocarbon radical having 1 to 20 carbon atoms, and it also being possible for the radicals R to be linked to one another with formation of a ring and n being an integer from 1 to 5, or
ab) reaction of phosgene, diphosgene or triphosgene with the abovementioned alcohol II) with elimination of hydrogen chloride
   and
b) intermolecular reaction of the condensates K) to give a highly functional, highly branched or hyperbranched polycarbonate,
   the ratio of the OH groups to the carbonates in the reaction mixture being chosen so that the condensates K) have on average either one carbonate group and more than one OH group or one OH group and more than one carbonate group.

Phosgene, diphosgene or triphosgene may be used as starting material, organic carbonates being preferred.

The radicals R of the organic carbonates I) of the general formula RO(CO)OR which are used as starting material are in each case independently of one another a straight-chain or branched aliphatic, aromatic/aliphatic or aromatic hydrocarbon radical having 1 to 20 carbon atoms. The two radicals R can also be linked to one another with formation of a ring. It is preferably an aliphatic hydrocarbon radical and particularly preferably a straight-chain or branched alkyl radical having 1 to 5 carbon atoms, or a substituted or unsubstituted phenyl radical.

In particular, simple carbonates of the formula RO(CO)ₙOR are used; n is preferably from 1 to 3, in particular 1.

Dialkyl or diaryl carbonates can be prepared, for example, from the reaction of aliphatic, araliphatic or aromatic alcohols, preferably monoalcohols, with phosgene. Furthermore, they can also be prepared by oxidative carbonylation of the alcohols or phenols by means of CO in the presence of noble metals, oxygen or NOₓ. Regarding preparation methods of diaryl or dialkyl carbonates, cf. also “Ullmann's Encyclopedia of Industrial Chemistry”, 6th Edition, 2000 Electronic Release, Verlag Wiley-VCH.

Examples of suitable carbonates comprise aliphatic, aromatic/aliphatic or aromatic carbonates, such as ethylene carbonate, 1,2- or 1,3-propylene carbonate, diphenyl carbonate, ditolyl carbonate, dixylyl carbonate, dinaphthyl carbonate, ethylphenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate or didodecyl carbonate.

Examples of carbonates in which n is greater than 1 comprise dialkyl dicarbonates, such as di(tert-butyl) dicarbonate, or dialkyl tricarbonates, such as di(tert-butyl) tricarbonate.

Aliphatic carbonates are preferably used, in particular those in which the radicals comprise 1 to 5 carbon atoms, such as, for example, dimethyl carbonate, diethyl carbonate, dipropyl carbonate, dibutyl carbonate or diisobutyl carbonate.

The organic carbonates are reacted with at least one aliphatic alcohol II) which has at least 3 OH groups or mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, pentaglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucids, hexahydroxybenzene, 1,3,5-benzenetrimethanol, 1,1,1-tris(4′-hydroxyphenyl)methane, 1,1,1-tris(4′-hydroxyphenyl)ethane, bis(trimethylolpropane) or sugars, such as, for example, glucose, trifunctional or higher-functional polyetherols based on trifunctional or higher-functional alcohols ad ethylene oxide, propylene oxide or butylene oxide, or polyesterols. Glycerol, trimethylolethane, trimethylolpropane, 1,2,4-butanetriol, pentaerythritol and the polyetherols thereof based on ethylene oxide or propylene oxide are particularly preferred.

These polyfunctional alcohols can also be used as a mixture with difunctional alcohols II′), with the proviso that the average OH functionality of all alcohols used together is greater than 2. Examples of suitable compounds having two OH groups comprise ethylene glycol, diethylene glycol, triethylene glycol, 1,2- and 1,3-propanediol, dipropylene glycol, tripropylene glycol, neopentylglycol, 1,2-, 1,3- and 1,4-butanediol, 1,2-, 1,3- and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxybiphenyl, bis(4-hydroxyphenyl)sulfide, bis(4-hydroxyphenyl)sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, difunctional polyetherpolyols based on ethylene oxide, propylene oxide, butylene oxide or mixtures thereof, polytetrahydrofuran, polycaprolactone or polyesterols based on diols and dicarboxylic acids.

The diols serve for fine adjustment of the properties of the polycarbonate. If difunctional alcohols are used, the ratio of difunctional alcohols II′) to the at least trifunctional alcohols II) is determined by the person skilled in the art according to the desired properties of the polycarbonate. As a rule, the amount of the difunctional alcohol or alcohols II′) is from 0 to 39.9 mol %, based on the total amount of all alcohols II) and II′) together. This amount is preferably from 0 to 35 mol %, particularly preferably from 0 to 25 mol % and very particularly preferably from 0 to 10 mol %.

The reaction of phosgene, diphosgene or triphosgene with the alcohol or alcohol mixture takes place as a rule with elimination of hydrogen chloride, and the reaction of the carbonates with the alcohol or alcohol mixture to give the highly functional highly branched polycarbonate takes place with elimination of the monofunctional alcohol or phenol from the carbonate molecule.

The highly functional highly branched polycarbonates A1) formed by the process are terminated with hydroxyl groups and/or with carbonate groups after the reaction, i.e. without further modification. They dissolve readily in various solvents, for example in water, alcohols, such as methanol, ethanol or butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate.

In the context of this invention, a highly functional polycarbonate is to be understood as meaning a product which, in addition to the carbonate groups which form the polymer backbone, furthermore has at least three, preferably at least six, more preferably at least ten, functional end or side groups. The functional groups are carbonate groups and/or OH groups. The number of functional end or side groups has in principle no upper limit, but products having a very large number of functional groups may have undesired properties, such as, for example, high viscosity or poor solubility. The highly functional polycarbonates of the present invention generally have not more than 500 functional end or side groups, preferably not more than 100 functional end or side groups.

In the preparation of the highly functional polycarbonates A1), it is necessary to adjust the ratio of the compounds comprising OH groups to phosgene or carbonate so that the resulting simplest condensate (referred to below as condensate (K)) comprises on average either one carbonate group or carbamoyl group and more than one OH group or one OH group and more than one carbonate group or carbamoyl group. The simplest structure of the condensate K) comprising a carbonate I) and a di- or polyalcohol II) gives the arrangement XYₙ or YₙX, where X is a carbonate group, Y is a hydroxyl group and n is as a rule a number from 1 to 6, preferably from 1 to 4, particularly preferably from 1 to 3. The reactive group, which results as the only group, is referred to below generally as “focal group”.

If, for example, in the preparation of the simplest condensate (K) from a carbonate and a dihydric alcohol, the conversion ratio is 1:1, the result on average is one molecule of the type XY, illustrated by the general formula 1.

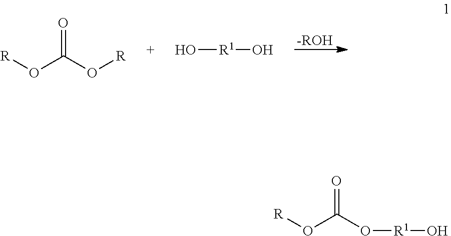

In the preparation of the condensate K) from a carbonate and a trihydric alcohol at a conversion ratio of 1:1, the result on average is one molecule of the type XY₂, illustrated by the general formula 2. Here, the focal group is a carbonate group.

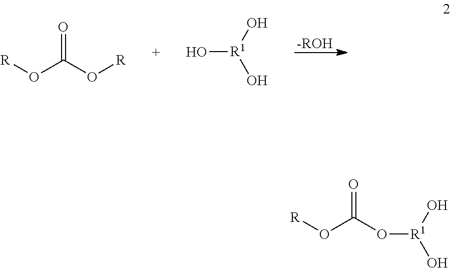

In the preparation of the condensate K) from a carbonate and a tetrahydric alcohol, likewise with a conversion ratio of 1:1, the result on average is one molecule of the type XY₃, illustrated by the general formula 3. The focal group here is a carbonate group.

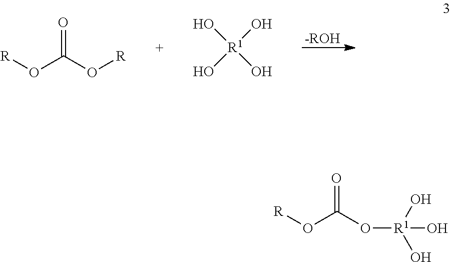

In the formulae 1 to 3, R has the meaning defined at the outset and R¹ is an aliphatic or aromatic radical.

Furthermore, the preparation of the condensate K) can also be effected, for example, from a carbonate and a trihydric alcohol, illustrated by the general formula 4, the molar conversion ratio being 2:1. Here, the result on average is one molecule of the type X₂Y, and the focal group here is an OH group. In the formula 4, R and R¹ have the same meaning as in the formulae 1 to 3.

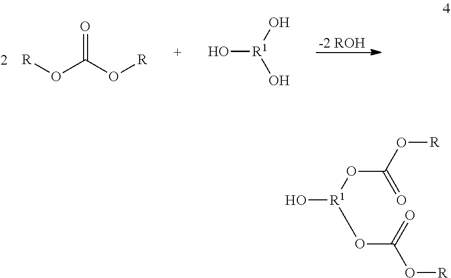

If difunctional compounds, e.g. a dicarbonate or a diol, are also added to the components, this results in a lengthening of the chains, as illustrated, for example, in the general formula 5. Once again, the result is on average one molecule of the type XY₂, and the focal group is a carbonate group.

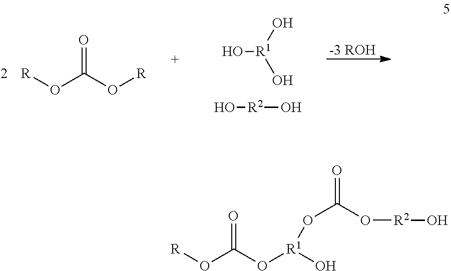

In formula 5, R² is an organic, preferably aliphatic radical and R and R¹ are defined as described above.

It is also possible to use a plurality of condensates K) for the synthesis. It is possible here on the one hand to use a plurality of alcohols or a plurality of carbonates. Furthermore, mixtures of different condensates of different structures can be obtained through the choice of the ratio of the alcohols used and of the carbonates or the phosgenes. This is explained by way of example for the reaction of a carbonate with a trihydric alcohol. If the starting materials are used in the ratio 1:1, as shown in formula 2, a molecule XY₂ is obtained. If the starting materials are used in the ratio 2:1, as shown in formula 4, a molecule X₂Y is obtained. In the case of a ratio between 1:1 and 2:1 a mixture of molecules XY₂ and X₂Y is obtained.

The simple condensates K) described by way of example in the formulae 1 to 5 preferably undergo, according to the invention, an intermolecular reaction with formation of highly functional polycondensates, referred to below as polycondensates P). The reaction to give the condensate K) and to give the polycondensate P) is usually effected at a temperature of from 0 to 250° C., preferably from 60 to 160° C., in the absence of a solvent or in solution. In general, all solvents which are inert to the respective starting materials may be used. Organic solvents, such as, for example, decane, dodecane, benzene, toluene, chlorobenzene, xylene, dimethylformamide, dimethylacetamide or solvent naphtha, are preferably used.

In a preferred embodiment, the condensation reaction is carried out in the absence of a solvent. The monofunctional alcohol ROH liberated in the reaction or the phenol can be removed from the reaction equilibrium by distillation, if appropriate at reduced pressure, in order to accelerate the reaction.

If removal by distillation is intended, it is as a rule advisable to use those carbonates which liberate alcohols ROH having a boiling point of less than 140° C. in the reaction.

For accelerating the reaction, it is also possible to add catalysts or catalyst mixtures. Suitable catalysts are compounds which catalyze esterification or transesterification reactions, for example alkali metal hydroxides, alkali metal carbonates, alkali metal bicarbonates, preferably of sodium, potassium or cesium, tertiary amines, guanidines, ammonium compounds, phosphonium compounds, organic compounds of aluminum, of tin, of zinc, of titanium, of zirconium or of bismuth, and furthermore so-called double metal cyanide (DMC) catalysts, as described, for example, in DE 10138216 or in DE 10147712.

Potassium hydroxide, potassium carbonate, potassium bicarbonate, diazabicyclooctane (DABCO), diazabicyclononene (DBN), diazabicycloundecene (DBU), imidazoles, such as imidazole, 1-methylimidazole or 1,2-dimethylimidazole, titanium tetrabutylate, titanium tetraisopropylate, dibutyltin oxide, dibutytin dilaurate, tin dioctanoate, zirconium acetylacetonate or mixtures thereof are preferably used.

The catalyst is generally added in an amount of from 50 to 10 000, preferably from 100 to 5000, ppmw, based on the amount of the alcohol or alcohol mixture used.

Furthermore, it is also possible to control the intermolecular polycondensation reaction both by addition of the suitable catalyst and by the choice of a suitable temperature. Furthermore, the average molecular weight in the polymer P) can be adjusted via the composition of the starting components and via the residence time.

The condensates K) or the polycondensates P) which were prepared at elevated temperature are usually stable over a relatively long period at room temperature.

Owing to the character of the condensates K), it is possible for polycondensates P) which have different structures and which have branches but no crosslinking to result from the condensation reaction. Furthermore, the polycondensates P) ideally have either one carbonate group as a focal group and more than two OH groups or one OH group as a focal group and more than two carbonate groups. The number of reactive groups is determined by the character of the condensates K) used and the degree of polycondensation.

For example, a condensate K) according to the general formula 2 can undergo a triple intermolecular condensation reaction to give two different polycondensates P), which are shown in the general formulae 6 and 7.

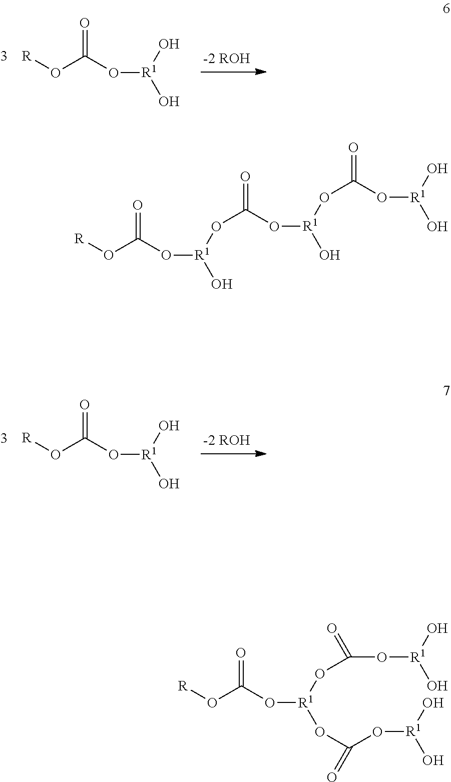

In formulae 6 and 7, R and R¹ are as defined above.

There are various possibilities for stopping the intermolecular polycondensation reaction. For example, the temperature can be reduced to a range in which the reaction comes to a stop and the product K) or the polycondensate P) is storage-stable.

Furthermore, the catalyst can be deactivated, for example by adding Lewis acids or protic acids in the case of basic catalysts.

In a further embodiment, as soon as a polycondensate P) having the desired degree of polycondensation is present as a result of the intermolecular reaction of the condensate K), a product having groups reactive toward the focal group of P) can be added to the product P) for stopping the reaction. Thus, in the case of a carbonate group as focal group, for example, a mono-, di- or polyamine can be added. In the case of a hydroxyl group as focal group, for example, a mono-, di- or polyisocyanate, a compound comprising epoxide groups or an acid derivative reactive with OH groups can be added to the product P).

The highly functional polycarbonates according to the invention are generally prepared in a pressure range of from 0.1 mbar to 20 bar, preferably from 1 mbar to 5 bar, in reactors or reactor cascades which are operated batchwise, semi-continuously or continuously.

Through the abovementioned establishment of the reaction conditions and, if appropriate, through the choice of the suitable solvent, the product can be further processed after the preparation without further purification.

In a further preferred embodiment, the product is stripped, i.e. freed from low molecular weight, volatile compounds. For this purpose, after the desired conversion has been reached, the catalyst can optionally be deactivated and the low molecular weight volatile constituents, e.g. monoalcohols, phenols, carbonates, hydrogen chloride or readily volatile oligomeric or cyclic compounds, can be removed by distillation, if appropriate while passing in a gas, preferably nitrogen, carbon dioxide or air, if appropriate at reduced pressure.

In a further preferred embodiment, the polycarbonates may acquire further functional groups in addition to the functional groups already acquired through the reaction. The functionalization can be effected during the increase in molecular weight or subsequently, i.e. after the end of the actual polycondensation.

If components which, in addition to hydroxyl or carbonate groups, have further functional groups or functional elements are added before or during the molecular weight increase, a polycarbonate polymer having randomly distributed functionalities differing from the carbonate or hydroxyl groups is obtained.

Such effects can be achieved, for example, by adding, during the polycondensation, compounds which, in addition to hydroxyl groups, carbonate groups or carbamoyl groups, carry further functional groups or functional elements, such as mercapto groups, ether groups, derivatives of carboxylic acids, derivatives of sulfonic acids, derivatives of phosphonic acids, silane groups, siloxane groups, aryl radicals or long-chain alkyl radicals.

For the modification with mercapto groups, for example, mercaptoethanol can be used. Ether groups can be generated, for example, by incorporation of difunctional or higher-functional polyetherols by condensation. Long-chain alkyl radicals can be introduced by reaction with long-chain alkanediols.

Ester groups can be produced by adding dicarboxylic acids, tricarboxylic acids, e.g. dimethyl terephthalate, or tricarboxylic esters.

A subsequent functionalization can be obtained by reacting the resulting highly functional, highly branched or hyperbranched polycarbonate in an additional process step (step c)) with a suitable functionalization reagent which can react with the OH and/or carbonate groups or carbamoyl groups of the polycarbonate.

Highly functional, highly branched or hyperbranched polycarbonates comprising hydroxyl groups can be modified, for example, by addition of molecules comprising acid groups. For example, polycarbonates comprising acid groups can be obtained by reaction with compounds comprising anhydride groups.

The introduction of the nitrogen atoms present according to the invention into the polycarbonates A1) is described further below.

Furthermore, highly functional polycarbonates comprising hydroxyl groups can also be converted into highly functional polycarbonate-polyetherpolyols by reaction with alkylene oxides, for example ethylene oxide, propylene oxide or butylene oxide.

A major advantage of the process for the preparation of the polycarbonates A1) is its cost-efficiency. Both the reaction to give a condensate K) or polycondensate P) and the reaction of K) or P) to give polycarbonates having other functional groups or elements can be effected in one reaction apparatus, which is technically and economically advantageous.

The highly branched or hyperbranched polyester A2) is preferably of the type AₓB_{y}, where

x is at least 1.1, preferably at least 1.3, in particular at least 2

y is at least 2.1, preferably at least 2.5, in particular at least 3.

Of course, mixtures can also be used as units A or B.

A polyester of the type AₓB_{y} is understood as meaning a condensate which is composed of an x-functional molecule A and a y-functional molecule B. A polyester comprising adipic acid as molecule A (x=2) and glycerol as molecule B (y=3) may be mentioned by way of example.

In the context of this invention, hyperbranched polyesters A2) are understood as meaning uncrosslinked macromolecules having hydroxyl and carboxyl groups, which have both structural and molecular non-uniformity. They can on the one hand have a composition starting from a central molecule analogous to dendrimers but with a non-uniform chain length of the branches. They can on the other hand also have a linear composition with functional side groups or can have linear and branched molecular moieties as a combination of the two extremes. For a definition of dendrimeric and hyperbranched polymers, also see P. J. Flory, J. Am. Chem. Soc. 1952, 74, 2718 and H. Frey et al., Chem. Eur. J. 2000, 6, No. 14, 2499.

In relation to the present invention, “hyperbranched” is understood as meaning that the degree of branching (DB), i.e. the average number of dendritic linkages plus the average number of end groups per molecule, is from 10 to 99.9%, preferably from 20 to 99%, particularly preferably 20-95%. In relation to the present invention, “dendrimeric” is understood as meaning that the degree of branching is 99.9-100%. For a definition of the “degree of branching”, cf. H. Frey et al., Acta Polym. 1997, 48, 30 and formulae mentioned above under B1).

The polyester A2) preferably has an Mₙ of from 300 to 30 000, in particular from 400 to 25 000 and very particularly from 500 to 20 000 g/mol, determined by means of GPC using PMMA as a standard and dimethylacetamide as a mobile phase.

Preferably, A2) has an OH number of from 0 to 600, preferably from 1 to 500, in particular from 20 to 500, mg KOH/g of polyester according to DIN 53240 and preferably a COOH number of from 0 to 600, preferably from 1 to 500 and in particular from 2 to 500 mg KOH/g of polyester.

The glass transition temperature Tg is preferably from −50° C. to 140° C. and in particular from −50 to 100° C., determined by means of DSC according to DIN 53765.

Preferred polyesters A2) are in particular those in which at least one OH or COOH number is greater than 0, preferably greater than 0.1 and in particular greater than 0.5.

The polyester A2) is preferably obtainable by the processes described below, in which
(a) one or more dicarboxylic acids or one or more derivatives thereof are reacted with one or more at least trifunctional alcohols

or
(b) one or more tricarboxylic acids or higher polycarboxylic acids or one or more derivatives thereof are reacted with one or more diols
   in the presence of a solvent and optionally in the presence of an inorganic, organometallic or low molecular weight organic catalyst or of an enzyme. The reaction in the solvent is the preferred preparation method.

Highly functional hyperbranched polyesters A2) in the context of the present invention have a molecular and structural nonuniformity. They differ in their molecular nonuniformity from dendrimers and can therefore be prepared with considerably less effort.

The dicarboxylic acids which can be reacted according to variant (a) include, for example, oxalic acid, malonic acid, succinic acid, glutaric acid, adipic acid, pimelic acid, suberic acid, azelaic acid, sebacic acid, undecane-α-ω-dicarboxylic acid, dodecane-α-ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid and cis- and trans-cyclopentane-1,3-dicarboxylic acid,

it being possible for the abovementioned dicarboxylic acids to be substituted by one or more radicals selected from

C₁-C₁₀-alkyl groups, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl,

C₃-C₁₂-cycloalkyl groups, for example cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred;

alkylene groups, such as methylene or ethylidene, or

C₆-C₁₄-aryl groups, such as, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

The following may be mentioned as exemplary members of substituted dicarboxylic acids: 2-methylmalonic acid, 2-ethylmalonic acid, 2-phenylmalonic acid, 2-methylsuccinic acid, 2-ethylsuccinic acid, 2-phenylsuccinic acid, itaconic acid and 3,3-dimethylglutaric acid.

Furthermore, the dicarboxylic acids which can be reacted according to variant (a) include ethylenically unsaturated acids, such as, for example, maleic acid and fumaric acid, and aromatic dicarboxylic acids, such as, for example, phthalic acid, isophthalic acid or terephthalic acid.

It is furthermore possible to use mixtures of two or more of the abovementioned members.

The dicarboxylic acids can be used either as such or in the form of derivatives. Derivatives are preferably understood as meaning
the relevant anhydrides in monomeric or polymeric form,
mono- or dialkyl esters, preferably mono- or dimethyl esters or the corresponding mono- or diethyl esters, but also the mono- and dialkyl esters derived from higher alcohols, such as, for example, n-propanol, isopropanol, n-butanol, isobutanol, tert-butanol, n-pentanol or n-hexanol,
furthermore mono- and divinyl esters and
mixed esters, preferably methyl ethyl esters.

In the preferred preparation, it is also possible to use a mixture of a dicarboxylic acid and one or more of its derivatives. Likewise, it is possible to use a mixture of a plurality of different derivatives of one or more dicarboxylic acids.

Particularly preferably, succinic acid, glutaric acid, adipic acid, phthalic acid, isophthalic acid, terephthalic acid or the mono- or dimethyl esters thereof are used. Adipic acid is very particularly preferably used.

For example, the following may be reacted as at least trifunctional alcohols: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as, for example, mesoerythritol, threitol, sorbitol, mannitol or mixtures of the above at least trifunctional alcohols. Glycerol, trimethylolpropane, trimethylolethane and pentaerythritol are preferably used.

Tricarboxylic acids or polycarboxylic acids which can be reacted according to variant (b) are, for example, 1,2,4-benzenetricarboxylic acid, 1,3,5-benzenetricarboxylic acid, 1,2,4,5-benzenetetracarboxylic acid and mellitic acid.

Tricarboxylic acids or polycarboxylic acids can be used in the reaction according to the invention either as such or in the form of derivatives. Derivatives are preferably understood as meaning
the relevant anhydrides in monomeric or polymeric form,
mono-, di- or trialkyl esters, preferably mono-, di- or trimethyl esters or the corresponding mono-, di- or triethyl esters, but also the mono-, di- and triesters derived from higher alcohols, such as, for example, n-propanol, isopropanol, n-butanol, isobutanol, tert-butanol, n-pentanol or n-hexanol, and furthermore mono-, di- or trivinyl esters
and mixed methyl ethyl esters.

In the present invention, it is also possible to use a mixture of a tri- or polycarboxylic acid and one or more of its derivatives. Likewise, it is possible in the present invention to use a mixture of a plurality of different derivatives of one or more tri- or polycarboxylic acids in order to obtain the polyester A2).

For example, ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols of the general formula HO(CH₂CH₂O)ₙ—H or polypropylene glycols of the general formula HO(CH[CH₃]CH₂O)ₙ—H or mixtures of two or more members of the above compounds, where n is an integer and preferably ≧4, are used as diols for variant (b) of the polyester preparation. One or both hydroxyl groups in the above diols can be substituted by SH groups. Preferred diols are ethylene glycol, propane-1,2-diol and diethylene glycol, triethylene glycol, dipropylene glycol and tripropylene glycol.

The molar ratio of the molecules A to molecules B in the AₓB_{y} polyester in the variants (a) and (b) is from 4:1 to 1:4, in particular from 2:1 to 1:2.

The at least trifunctional alcohols reacted according to variant (a) of the process may have hydroxyl groups of the same reactivity in each case. Also preferred here are at least trifunctional alcohols whose OH groups initially have the same reactivity but in which a decrease in reactivity due to steric or electronic influences can be induced in the remaining OH groups by reaction with at least one acid group. This is the case, for example, with the use of trimethylolpropane or pentaerythritol.

The at least trifunctional alcohols reacted according to variant (a) can, however, also have hydroxyl groups having at least two chemically different reactivities.

The different reactivity of the functional groups may have either chemical (e.g. primary/secondary/tertiary OH group) or steric causes. For example, the triol may be a triol which has primary and secondary hydroxyl groups, a preferred example being glycerol.

The reaction according to the invention according to variant (a) is preferably carried out in the absence of diols and monofunctional alcohols.

The reaction according to the invention according to variant (b) is preferably carried out in the absence of mono- or dicarboxylic acids.

The process for the preparation of the polyesters A2) is carried out in the presence of a solvent. For example, hydrocarbons such as paraffins or aromatics are suitable. Particularly suitable paraffins are n-heptane and cyclohexane. Particularly suitable aromatics are toluene, ortho-xylene, meta-xylene, para-xylene, xylene as an isomer mixture, ethylbenzene, chlorobenzene and ortho- and meta-dichlorobenzene. Furthermore, solvents which are very particularly suitable in the absence of acidic catalysts are ethers, such as, for example, dioxane or tetrahydrofuran, and ketones, such as, for example, methyl ethyl ketone and methyl isobutyl ketone.

The amount of added solvent is usually at least 0.1% by weight, based on the mass of the starting materials used which are to be reacted, preferably at least 1% by weight and particularly preferably at least 10% by weight. It is also possible to use excess amounts of solvent, based on the mass of starting materials used which are to be reacted, for example a 1.01- to 10-fold amount. Amounts of solvent of more than 100-fold, based on the mass of starting materials used which are to be reacted are not advantageous because, at substantially lower concentrations of the reactants, the reaction rate substantially declines, which leads to uneconomical long durations of reaction.

The process preferred according to the invention can be carried out in the presence of a dehydrating agent as an additive, which is added at the beginning of the reaction. For example, molecular sieves, in particular molecular sieve 0.4 nm (4 Å), MgSO₄ and Na₂SO₄ are suitable. During the reaction, further dehydrating agents can also be added or dehydrating agent can be replaced by fresh dehydrating agent. Water or alcohol formed during the reaction can be distilled off, and, for example, a water separator may be used.

The process can be carried out in the absence of acidic catalysts. It is preferable to work in the presence of an acidic inorganic, organometallic or organic catalyst or mixtures of a plurality of acidic inorganic, organometallic or organic catalysts.

For example, sulfuric acid, phosphoric acid, phosphonic acid, hypophosphorous acid, aluminum sulfate hydrate, alum, acidic silica gel (pH=6, in particular=5) and acidic alumina may be mentioned as acidic inorganic catalysts. Furthermore, it is possible to use, for example, aluminum compounds of the general formula Al(OR)₃ and titanates of the general formula Ti(OR)₄ as acidic inorganic catalysts, where the radicals R in each case may be identical or different and, independently of one another, are selected from

C₁-C₁₀-alkyl radicals, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl,

C₃-C₁₂-cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred.

Preferably, the radicals R in Al(OR)₃ or Ti(OR)₄ are in each case identical and are selected from isopropyl or 2-ethylhexyl.

Preferred acidic organometallic catalysts are selected, for example, from dialkyltin oxides R₂SnO, where R is as defined above. A particularly preferred member of acidic organometallic catalysts is di-n-butyltin oxide, which is commercially available as so-called oxo-tin, or di-n-butyltin dilaurate.

Preferred acidic organic catalysts are acidic organic compounds having, for example, phosphate groups, sulfo groups, sulfate groups or phosphonic acid groups. Particularly preferred are sulfonic acids such as, for example, para-toluenesulfonic acid. It is also possible to use acidic ion exchangers as acidic organic catalysts, for example polystyrene resins which comprise sulfo groups and are crosslinked with about 2 mol % of divinylbenzene.

Combinations of two or more of the above catalysts may also be used. It is also possible to use those organic or organometallic or inorganic catalysts which are present in the form of discrete molecules, in immobilized form.

If it is desired to use acidic inorganic, organometallic or organic catalysts, usually from 0.1 to 10% by weight, preferably from 0.2 to 2% by weight, of catalyst are used.

The process is preferably carried out under an inert gas atmosphere, i.e. for example under carbon dioxide, nitrogen or noble gas, among which argon may be mentioned in particular.

The process is carried out as a rule at temperatures of from 60 to 200° C. Temperatures of from 130 to 180° C., in particular up to 150° C. or below, are preferably employed. Maximum temperatures are particularly preferably up to 145° C., very particularly preferably up to 135° C.

The pressure conditions are usually not critical. It is possible to employ substantially reduced pressure, for example from 10 to 500 mbar. The process according to the invention can also be carried out at pressures above 500 mbar. For reasons of simplicity, the reaction at atmospheric pressure is preferred; however, it is also possible to carry it out at slightly superatmospheric pressure, for example up to 1200 mbar. It is also possible to employ substantially superatmospheric pressure, for example pressures up to 10 bar.

The duration of reaction is usually from 10 minutes to 25 hours, preferably from 30 minutes to 10 hours and particularly preferably from one to 8 hours.

After the end of the reaction, the highly functional hyperbranched polyesters A2) can be easily isolated, for example by filtering off the catalyst and concentrating, the concentrating usually being carried out at reduced pressure. Further suitable working-up methods are precipitation after addition of water and subsequent washing and drying.

Furthermore, the polyester A2) can be prepared in the presence of enzymes or decomposition products of enzymes, cf. DE-A 101 63163; this is referred to below as enzymatic process. The reacted dicarboxylic acids are not among the acidic organic catalysts in the context of the present invention.

The use of lipases or esterases is preferred. Suitable lipases and esterases are Candida cylindracea, Candida lipolytica, Candida rugosa, Candida antarctica, Candida utilis, Chromobacterium viscosum, Geolrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterases of Bacillus spp. and Bacillus thermoglucosidasius. Candida antarctica Lipase B is particularly preferred. The enzymes mentioned are commercially available, for example from Novozymes Biotech Inc., Denmark.

The enzyme is preferably used in immobilized form, for example on silica gel or Lewatit® ion exchangers. Methods for immobilizing enzymes are known per se, for example from Kurt Faber, “Biotransformations in organic chemistry”, 3rd edition 1997, Springer Verlag, section 3.2 “Immobilization”, pages 345-356. Immobilized enzymes are commercially available, for example from Novozymes Biotech Inc., Denmark.

The amount of immobilized enzyme used is from 0.1 to 20% by weight, in particular from 10 to 15% by weight, based on the mass of the starting materials to be reacted which are used altogether.

The enzymatic process is carried out as a rule at temperatures above 60° C. Preferably, temperatures of 100° C. or less are employed. Temperatures up to 80° C. are preferred, very particularly preferably from 62 to 75° C. and even more preferably from 65 to 75° C.

The enzymatic process, too, is carried out in the presence of a solvent, as described further above. The amount of added solvent is at least 5 parts by weight, based on the mass of the starting materials to be reacted which are used, preferably at least 50 parts by weight and particularly preferably at least 100 parts by weight. Amounts above 10 000 parts by weight of solvent are not desired because the reaction rate declines substantially at substantially lower concentrations, which leads to uneconomical long durations of reaction.

The enzymatic process is usually carried out at pressures above 500 mbar. The reaction at atmospheric pressure or slightly superatmospheric pressure, for example up to 1200 mbar, is preferred. It is also possible to employ substantially superatmospheric pressure, for example pressures up to 10 bar. The reaction at atmospheric pressure is preferred.

The duration of reaction of the enzymatic process is usually from 4 hours to 6 days, preferably from 5 hours to 5 days and particularly preferably from 8 hours to 4 days.

After the end of the reaction, the highly functional hyperbranched polyesters can be isolated, for example by filtering off the enzyme and concentrating, the concentrating usually being carried out at reduced pressure. Further suitable working-up methods are precipitation after addition of water and subsequent washing and drying.

The highly functional, hyperbranched polyesters A2) obtainable by the process are distinguished by particularly low levels of discolorations and resinifications. For a definition of hyperbranched polymers, also see: P. J. Flory, J. Am. Chem. Soc. 1952, 74, 2718 and A. Sunder et al., Chem. Eur. J. 2000, 6, No. 1, 1-8.

In relation to the present invention, “highly functional hyperbranched” is understood as meaning that the degree of branching, i.e. the average number of dendritic linkages plus the average number of end groups per molecule, is from 10 to 99.9%, preferably from 20 to 99%, particularly preferably from 30 to 90% (in this context, cf. H. Frey et al. Acta Polym. 1997, 48, 30).

The polyesters A2) have, as a rule, a molecular weight M_{w} of from 500 to 50 000 g/mol, preferably from 1000 to 20 000, particularly preferably from 1000 to 19 000. The polydispersity is from 1.2 to 50, preferably from 1.4 to 40, particularly preferably from 1.5 to 30 and very particularly preferably from 1.5 to 10. They are usually readily soluble, i.e. it is possible to prepare clear solutions with up to 50% by weight, in some cases even up to 80% by weight, of the polyesters in tetrahydrofuran (THF), n-butyl acetate, ethanol and numerous other solvents, without gel particles being detectable with the naked eye.

The highly functional hyperbranched polyesters according to the invention are carboxyl-terminated, terminated by carboxyl and hydroxyl groups and preferably terminated by hydroxyl groups.

The introduction of the nitrogen atoms present according to the invention into the polyesters A2) is described further below.

It is possible to use either the polycarbonates A1) or the polyesters A2) or mixtures thereof. If the polycarbonates A1) and the polyesters A2) are used as a mixture, the weight ratio A1):A2) is preferably from 1:20 to 20:1, in particular from 1:15 to 15:1 and very particularly from 1:5 to 5:1.

The polymers A1) or A2) used have as a rule at least three functional groups. The number of functional groups in principle has no upper limit. However, products having too large a number of functional groups frequently have undesired properties, such as, for example, poor solubility and a very high viscosity. The highly branched polymers used according to the invention therefore have as a rule not more than on average 100 functional groups. The highly branched polymers preferably have on average from 3 to 50 and particularly preferably from 3 to 20 functional groups.

The hyperbranched polycarbonates A1) or polyesters A2) can be used as such or as a mixture with other polymers.

Functionalization of the Highly Branched or Hyperbranched Polymers A) with Nitrogen Atoms

According to the invention, the highly branched or hyperbranched polymer A), i.e. the polycarbonate A1) or the polyester A2), comprises nitrogen atoms. The nitrogen atoms are introduced into the polymer by means of a nitrogen-containing compound.

In a first preferred embodiment 1), in the process according to the invention for the preparation of POM, the polymer A) is obtainable by polymerizing suitable monomers to give the polymer A) and a nitrogen-containing compound is concomitantly used. Accordingly, in this embodiment 1) a nitrogen-containing compound is concomitantly used—virtually as a comonomer—in the preparation of the highly branched or hyperbranched polymers A.

In a second preferred embodiment 2), in the process according to the invention for the preparation of POM, the polymer A) is obtainable by first polymerizing suitable monomers to give a precursor polymer A*) and this precursor polymer A*) is then reacted with a nitrogen-containing compound to give the polymer A). The polymer A*), i.e. the polycarbonate A*1) or the polyester A*2), is the precursor of the polymer A), which precursor still comprises no nitrogen atoms. In this embodiment 2), the nitrogen-free precursor polymer A*) is therefore first prepared and is then refunctionalized with the nitrogen-containing compound.

The terms “comprising no nitrogen atoms” and “nitrogen-free” are not intended to rule out low nitrogen contents, as may enter the polymer A*) through contaminations, for example of the monomers, or through polymerization assistants (e.g. solvents, catalysts).

The following may be added for comprehension of the functionalization:

Highly branched or hyperbranched polymers A) having functional groups can be synthesized, for example, in a manner known per se using ABₓ monomers, preferably AB₂ monomers. The AB₂ monomers can firstly be incorporated completely in the form of branches, they can be incorporated as terminal groups, i.e. still have two free B groups, and they can be incorporated as linear groups having a free B group as a side group. Depending on the degree of polymerization, the highly branched polymers obtained have a larger or smaller number of B groups, either terminally or as side groups. Data on hyperbranched polymers and the synthesis thereof are to be found, for example, in J.M.S.—Rev. Macromol. Chem. Phys., C37(3), 555-579 (1997) and the literature cited there.

The originally present B groups are advantageously refunctionalized by polymer-analogous reaction with compounds suitable for this purpose.

Compounds used for the refunctionalization may firstly comprise the desired nitrogen-containing functional group to be newly introduced and a second group which is capable of reacting with the B groups of the highly branched polymer A) used as starting material with formation of a bond. However, it is also possible to use monofunctional compounds, by means of which groups B present are merely modified.

The refunctionalization according to embodiment 2) can advantageously be effected directly after the polymerization reaction or in a separate reaction.

It is also possible to produce hyperbranched polymers which have functionalities of different types. This can be effected, for example, by reaction with a mixture of different compounds for refunctionalization or by reacting only a part of the functional groups originally present.

Furthermore, it is possible to produce compounds having mixed functionality by using, as ABₓ compounds, monomers of the type ABC or AB₂C for the polymerization, where C is a functional group which is not reactive with A or B under the chosen reaction conditions.

Suitable nitrogen-containing compounds are—in both embodiments 1) and 2)—those which carry primary, secondary or tertiary amino groups as further functional groups in addition to hydroxyl groups, carboxyl groups, carbonate groups or carbamoyl groups.

Preferably and in both embodiments 1) and 2), the nitrogen-containing compound is an amine.

For modification by means of carbamate groups, for example, ethanolamine, propanolamine, isopropanolamine, 2-(butylamino)ethanol, 2-(cyclohexylamine)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethy)aminomethane, tris(hydroxyethyl)aminomethane, ethylenediamine, propylenediamine, hexamethylenediamine or isophoronediamine can be concomitantly used.

Tertiary amino groups can be produced, for example, by incorporation of N-methyldiethanolamine, N-methyldipropanolamine or N,N-dimethylethanolamine. A reaction with alkyl or aryl diisocyanates generates polycarbonates or polyesters having alkyl, aryl and urethane groups, urea groups or amido groups.

Furthermore, suitable amines are nitrogen-containing heterocyclic compounds, for example pyrroles, pyrrolidines, imidazoles, imidazolines, triazoles, triazolines, tetrazoles, pyrazoles, pyrazolines, oxazoles, oxazolines, thiazoles, thiazolines, pyridines, piperines, piperidines, pyrimidines, pyrazines and the substituted analogues of these heterocycles.

The amine is preferably selected from

i) sterically hindered amines i),

ii) aromatic amines ii), whose amino group is bonded directly to the aromatic system, and

iii) imidazoles iii).

Suitable sterically hindered amines i) are in particular those compounds which are referred to as HALS (hindered amine light stabilizers). Such compounds are known; they are usually added as an additive to a prepared polymer in order to stabilize it to photooxidative degradation (action of light). It has surprisingly been found that highly branched or hyperbranched polyesters or polycarbonates functionalized with HALS compounds are excellent deactivators in POM preparation.

Suitable HALS are in particular compounds of the formula

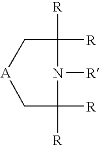

where

R are identical or different alkyl radicals, preferably methyl

R′ is hydrogen or an alkyl radical and

A is an optionally substituted 2- or 3-membered alkylene chain.

The sterically hindered amine i) is preferably an amine (HALS) based on 2,2,6,6-tetramethylpiperidine. Preferred HALS are, inter alia, the following derivatives of 2,2,6,6-tetramethylpiperidine:

4-acetoxy-2,2,6,6-tetramethylpiperidine,

4-stearoyloxy-2,2,6,6-tetramethylpiperidine,

4-aryloyloxy-2,2,6,6-tetramethylpiperidine,

4-methoxy-2,2,6,6-tetramethylpiperidine,

4-benzoyloxy-2,2,6,6-tetramethylpiperidine,

4-cyclohexyloxy-2,2,6,6-tetramethylpiperidine,

4-phenoxy-2,2,6,6-6-tetramethylpiperidine,

4-benzyloxy-2,2,6,6-tetramethylpiperidine, and

4-(phenylcarbamoyloxy)-2,2,6,6-tetramethylpiperidine.

Other preferred HALS are:

bis(2,2,6,6-tetramethyl-4-piperidyl)oxalate,

bis(2,2,6,6-tetramethyl-4-piperidyl)succinate,

bis(2,2,6,6-tetramethyl-4-piperidyl)malonate,

bis(2,2,6,6-tetramethyl-4-piperidyl)adipate,

bis(1,2,2,6,6-pentamethyl-piperidyl)sebacate,

bis(2,2,6,6-tetramethyl-4-piperidyl)terephthalate,

1,2-bis(2,2,6,6-tetramethyl-4-piperidyloxy)ethane,

bis(2,2,6,6-tetramethyl-4-piperidyl)hexamethylene-1,6-dicarbamate,

bis(1-methyl-2,2,6,6-tetramethyl-4-diperidyl)adipate, and

tris(2,2,6,6-tetramethyl-4-piperidyl)benzene-1,3,5-tricarboxylate.

Also preferred are higher molecular weight piperidine derivatives, for example the polymer of dimethyl butanedioate and 4-hydroxy-2,2,6,6-tetramethyl-1-piperidinethanol or poly-6-(1,1,3,3-tetramethylbutyl)amino-1,3,5-triazine-2,4-diyl(2,2,6,6-tetramethyl-4-piperidinyl)imino-1,6-hexanediyl(2,2,6,6-tetramethyl-14-piperidinyl)imino, and polycondensates of dimethyl succinate and 1-(2-hydroxyethyl)-4-hydroxy-2,2,6,6-tetramethylpiperidine, which, like bis(2,2,6,6-tetramethyl-4-piperidyl)sebacate, are particularly suitable.

Such compounds are commercially available under the name Tinuvin® or Chimasorb® from Ciba-Geigy.

The HALS compounds can be used in the form of the abovementioned 2,2,6,6-tetra-alkylpiperidines, but in addition the N atom, too, may be alkyl-substituted (i.e. in formula i) R′ is not hydrogen). For example, it is also possible to use 1,2,2,6,6-pentaalkylpiperidines, the alkyl radical preferably being methyl.

Moreover, those HALS whose piperidine ring is substituted by hydroxyl groups, amino groups, mercapto groups or other functional groups are also suitable. Position 4 is preferred, and HALS of the type

2,2,6,6-tetraalkylpiperidin-4-ol,

1,2,2,6,6-pentaalkylpiperidin-4-ol,

4-amino-2,2,6,6-tetraalkylpiperidine and

4-amino-1,2,2,6,6-pentaalkylpiperidine

may be mentioned by way of example, the alkyl radical preferably being methyl.

It is thought that the hydroxyl, amino or mercapto group facilitates the functionalization of the highly branched or hyperbranched polymer (polycarbonate A1) or polyester A2)) with the HALS. It is possible that the HALS molecule is bonded to the polycarbonate or the polyester via the hydroxyl, amino or mercapto group.

Particularly preferably, the sterically hindered amine i) is 1,2,2,6,6-pentamethylpiperidin-4-ol or 2,2,6,6-tetramethylpiperidin-4-ol or a mixture thereof.

In the process according to the invention, the polymer A) is very particularly preferably a highly branched or hyperbranched polycarbonate A1), in the preparation of which 1,2,2,6,6-pentamethylpiperidin-4-ol or 2,2,6,6-tetramethylpiperidin-4-ol or a mixture thereof is concomitantly used.

In the aromatic amines ii), the amino group is bonded directly (i.e. via a chemical bond without further atoms) to the aromatic system. The amino group may be unsubstituted or substituted.

Preferred aromatic amines ii) are those of the formula

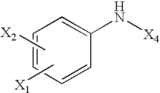

where
X₁, X₂, X₃, X₄, independently of one another, are hydrogen, alkyl or cycloalkyl having 1 to 12 carbon atoms and
X₄ may also be a (optionally alkyl- or cycloalkyl-substituted) phenyl radical.

Suitable imidazoles iii) are in principle imidazole (1,3-diazole) itself and substituted imidazoles. Imidazoles substituted by alkyl cycloalkyl or aryl radicals are preferred, the radicals having as a rule 1 to 12 carbon atoms. The radicals may carry heteroatoms, such as N, O, S or P, for example may be substituted by amino groups or hydroxyl groups.

Preferred imidazoles are those of the formula

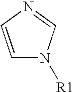

where R1 is hydrogen, alkyl aminoalkyl, hydroxyalkyl or mercaptoalkyl. In particular R1 is 3-aminopropyl or 2-hydroxypropyl.

The imidazole iii) is particularly preferably an aminoalkylimidazole, in particular a (3-aminoalkyl)imidazole. A particularly preferred imidazole iii) is 1-(3-aminopropyl)imidazole:

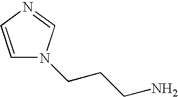

In the process according to the invention, the polymer A) is very particularly preferably a highly branched or hyperbranched polycarbonate A1), in the preparation of which 1-(3-aminopropyl)imidazole was concomitantly used.

Said amines are known and are commercially available or their preparation is familiar to the person skilled in the art. One or more different amines may be used.

The amount of the nitrogen-containing compounds (for example of the amines) depends, inter alia, on the desired content of nitrogen atoms in the polymer A). As a rule, the amount of nitrogen-containing compounds is
in embodiment 1) (concomitant use of nitrogen-containing compounds in the polymerization to give the polymer A)), from 1 to 90, preferably from 1 to 70 and particularly preferably from 5 to 50 mol %, based on the amount (in moles) of the alcohol component,
in embodiment 2) (preparation of a precursor polymer A*) and reaction with a nitrogen-containing compound), from 1 to 100, preferably from 5 to 100 and particularly preferably from 10 to 100 mol %, based on the free functional groups of the precursor polymer A*) which are capable of reacting with the nitrogen-containing compound.

It is of course also possible to use a plurality of nitrogen-containing compounds, e.g. amines. Moreover, the embodiments 1) and 2) may be combined, i.e. both concomitant use of a nitrogen-containing compound in the polymerization of the monomers and subsequently reaction of the resulting polymer A) with a—identical or different—nitrogen-containing compound and further increase in the number of N atoms in the polymer A) in this way.

The nitrogen-containing compounds can be used as such or in solution or dispersion, for example as an emulsion or suspension, in a suitable solvent or dispersing medium. Such solvents or dispersing media are, for example, the solvents mentioned further above in the preparation of the polycarbonates A1) or polyesters A2).

The reaction conditions in the reaction with the nitrogen-containing compounds are usually as follows in the two embodiments 1) and 2): temperature from −30 to 300, preferably from 0 to 280 and in particular from 20 to 280° C.; pressure from 0.001 to 20, preferably from 0.01 to 10 and in particular from 0.1 to 2 bar; duration from 0.1 to 48, preferably from 0.1 to 36 and particularly preferably from 0.5 to 24 hours.

The reaction can be carried out, for example, in a one-pot reaction directly in the reactor which, in embodiment 1), is used for the preparation of the highly branched or hyperbranched polycarbonate A1) or polyester A2) or, in embodiment 2), is used for the preparation of the precursor polymers A*1) or A*2).

Deactivation Step in the Process for POM Preparation

In the process according to the invention for POM preparation the special deactivator described above is added in a manner known per se to the reaction mixture present in the POM preparation, for example mixed into the polymerization melt.

It is possible to use the deactivator as such or—preferably—in solution or dispersion, for example as an emulsion or suspension, in a suitable solvent or dispersing medium. A very wide range of solvents or dispersing media is suitable, for example water, methanol, other alcohols or other organic solvents. However, solvents or dispersing media which are simultaneously used as monomers in the POM preparation are preferred. These include low molecular weight linear or cyclic acetals, such as 1,3-dioxolane, trioxane or butylal, but also high molecular weight molten POM.

Customary apparatuses can be used for metering the deactivator, for example pumps, extruders or other transport members. Rapid and homogeneous mixing of the deactivator with the reaction mixture, for example the melt, can be promoted by suitable apparatuses, for example stirrers, mixing pumps or mixing, shearing or kneading elements. The metering in and mixing of the deactivator can be effected, for example, in a so-called deactivation zone which is provided with moving (dynamic) internals, such as mixing pumps, gear pumps, kneaders, extruders, inline mixers with rotor and stator, cone mixers or stirred vessels and/or stationary (static) internals.

The temperature during the deactivation is, for example, from 130 to 230, preferably from 140 to 210 and in particular from 150 to 190° C. at a pressure of from 1 to 200, preferably from 5 to 150 and in particular from 10 to 100 bar. The duration (residence time) is usually from 1 to 1200, preferably from 10 to 600 and particularly preferably from 20 to 300 sec. As mentioned the deactivation is preferably effected without a phase change.

In the process according to the invention for the POM preparation preferably no other deactivator compounds are concomitantly used apart from the deactivators according to the invention. Such deactivator compounds which are preferably not concomitantly used would have been, for example, ammonia; primary, secondary and tertiary, aliphatic and aromatic amines (i.e. “monomeric” amines which are not bonded to highly branched or hyperbranched polycarbonates or polyesters), e.g. trialkylamines, such as triethylamine, triacetonediamine; basic salts, such as sodium carbonate and borax; the carbonates and hydroxides of the alkali metals and alkaline earth metals; alkali metal and alkaline earth metal alcoholates, such as sodium methanolate; or alkali metal or alkaline earth metal alkyls having, for example, 2 to 30 carbon atoms in the alkyl radical, such as n-butyllithium.

The melt polymerization and the devolatilization following the deactivation and comprising removal of residual monomers and, if appropriate, mixing of the POM with additives were described further above.

Advantages of the Process and Further Subjects of the Invention

In the process according to the invention, the deactivation is effected in a simple manner. It should be emphasized that the residual monomers recycled after the deactivation and devolatilization usually need not be purified or freed from the deactivator since the deactivator used according to the invention—in contrast to the deactivators used to date—does not pass over into the residual monomers in the removal of residual monomer or does so only to such a minor extent that the polymerization reaction is not disturbed.

The residual monomers can be recycled to the process in a simple manner, in particular without intermediate purification steps. This omission of the residual monomer purification improves the cost-efficiency of the overall process considerably.

The deactivator can be metered in in a simple manner, for example in liquid form or in solution in a very wide range of solvents which do not interfere with the polymerization reaction and do not impair the residual monomer recycling. It is effective even in small amounts and stops the polymerization reaction rapidly and reliably.

The invention also relates to the polyoxymethylene homo- or copolymers (POM) obtainable by the process according to the invention.

The invention furthermore relates to the use of the highly branched or hyperbranched polycarbonates A1) comprising nitrogen atoms in the preparation of polyoxymethylene homo- or copolymers (POM); and the use of the highly branched or hyperbranched polyesters A2) comprising nitrogen atoms in the preparation of polyoxymethylene homo- or copolymers (POM).

The invention also relates to the deactivator for deactivating the polymerization in the preparation of polyoxymethylene homo- or copolymers (POM), comprising a highly branched or hyperbranched polymer A), which is selected from highly branched or hyperbranched polycarbonates A1) and highly branched or hyperbranched polyesters A2), the polymer A) comprising nitrogen atoms.

### EXAMPLES

a) Preparation of the Deactivators Used According to the Invention

Deactivator D1:

216 g of a triol based on trimethylolpropane, randomly etherified with one mole of ethylene oxide per mole of hydroxyl groups, 34.3 g of 1,2,2,6,6-pentamethylpiperidin-4-ol and 118.1 g of diethyl carbonate were initially taken in a three-necked flask equipped with a stirrer, reflux condenser and internal thermometer, 0.1 g of potassium carbonate was then added and the mixture was heated to 140° C. with stirring and stirred at this temperature for 2.5 hours. With progressive duration of reaction, the temperature of the reaction mixture decreased owing to the onset of evaporative cooling of the ethanol liberated to about 115° C. After this temperature had been reached, the reflux condenser was exchanged for a descending condenser, ethanol was distilled off and the temperature of the reaction mixture was slowly increased to 200° C. The ethanol distilled off (75 g=80 mol %, based on full conversion) was collected in a cooled round-bottomed flask. Thereafter, the product was cooled to room temperature and analyzed by gel permeation chromatography; the mobile phase was dimethylacetamide, and polymethyl methacrylate (PMMA) was used as a calibration standard. The number average molecular weight Mn was 1100 g/mol and the weight average molecular weight Mw was 2500 g/mol. The viscosity, determined at23° C. according to DIN 53019, was 1200 mPa·s.

Deactivator D2:

162 g of a triol based on trimethylolpropane, randomly etherified with one mole of ethylene oxide per mole of hydroxyl groups, 68.5 g of 1,2,2,6,6-pentamethylpiperidin-4-ol and 118.1 g of diethylcarbonate were initially taken in a three-necked flask equipped with a stirrer, reflux condenser and internal thermometer, 0.1 g of potassium carbonate was then added and the mixture was heated to 140° C. with stirring and stirred at this temperature for 3.5 hours. With progressive duration of reaction, the temperature of the reaction mixture decreased owing to the onset of evaporative cooling of the ethanol liberated to about 110° C. After this temperature had been reached, the reflux condenser was exchanged for a descending condenser, ethanol was distilled off and the temperature of the reaction mixture was slowly increased to 200° C. The ethanol distilled off (72 g=78 mol %, based on full conversion) was collected in a cooled round-bottomed flask. Thereafter, the product was cooled to room temperature and analyzed by gel permeation chromatography; the mobile phase was dimethylacetamide, and polymethyl methacrylate (PMMA) was used as a calibration standard. The number average molecular weight Mn was 400 g/mol and the weight average molecular weight Mw was 1100 g/mol. The viscosity, determined at23° C. according to DIN 53019, was 1050 mPa·s.

Deactivator D3:

216 g of a triol based on trimethylolpropane, randomly etherified with one mole of ethylene oxide per mole of hydroxyl groups, 31.5 g of 2,2,6,6-tetramethylpiperidin-4-ol and 118.1 g of diethylcarbonate were initially taken in a three-necked flask equipped with a stirrer, reflux condenser and internal thermometer, 0.1 g of potassium carbonate was then added and the mixture was heated to 140° C. with stirring and stirred at this temperature for 3.5 hours. With progressive duration of reaction, the temperature of the reaction mixture decreased owing to the onset of evaporative cooling of the ethanol liberated to about 110° C. After this temperature had been reached, the reflux condenser was exchanged for a descending condenser, ethanol was distilled off and the temperature of the reaction mixture was slowly increased to 200° C. The ethanol distilled off (82 g=89 mol %, based on full conversion) was collected in a cooled round-bottomed flask. Thereafter, the product was devolatilized for 5 min at 140° C. and 80 mbar, cooled to room temperature and analyzed by gel permeation chromatography; the mobile phase was dimethylacetamide, and polymethyl methacrylate (PMMA) was used as a calibration standard. The number average molecular weight Mn was 1500 g/mol and the weight average molecular weight Mw was 3200 g/mol. The viscosity, determined at 23° C. according to DIN 53019, was 3400 mPa·s.

Deactivator D4:

162 g of a triol based on trimethylolpropane, randomly etherified with one mole of ethylene oxide per mole of hydroxyl groups, 50.1 g of 1-(3-aminopropyl)imidazole and 118.1 g of diethylcarbonate were initially taken in a three-necked flask equipped with a stirrer, reflux condenser and internal thermometer, 0.1 g of potassium carbonate was then added and the mixture was heated to 140° C. with stirring and stirred at this temperature for 3.5 hours. With progressive duration of reaction, the temperature of the reaction mixture decreased owing to the onset of evaporative cooling of the ethanol liberated to about 110° C. After this temperature had been reached, the reflux condenser was exchanged for a descending condenser, ethanol was distilled off and the temperature of the reaction mixture was slowly increased to 200° C. The ethanol distilled off (75 g=80 mol %, based on full conversion) was collected in a cooled round-bottomed flask. Thereafter, the product was devolatilized for 5 min at 140° C. and 80 mbar, cooled to room temperature and analyzed by gel permeation chromatography; the mobile phase was dimethylacetamide, and polymethyl methacrylate (PMMA) was used as a calibration standard. The number average molecular weight Mn was 950 g/mol and the weight average molecular weight Mw was 1900 g/mol. The viscosity, determined at 23° C. according to DIN 53019, was 12 100 mPa·s.

b) Deactivators C not According to the Invention for Comparison

Instead of the above deactivators D1 to D4, the monomeric compounds C (i.e. not bonded to a hyperbranched polymer) mentioned in table 1 were used not according to the invention. The deactivators C resemble the piperidine end groups of the deactivators D according to the invention.

TABLE 1
Monomeric deactivators C instead of D1 to D4, for comparison

| Deactivator | Name | Structural formula |
|---|---|---|
| C1 | 4-amino-2,2,6,6- tetramethylpiperidine | 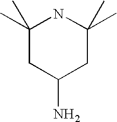 |
| C2 | Uvinul ® 4077 (from BASF) | 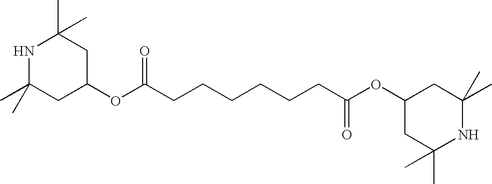 |
| C2 | Uvinul ® 4050H (from BASF) | 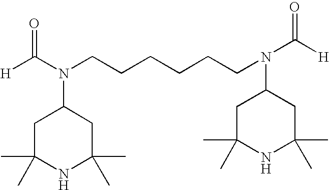 |
| C4 | 4-aminopyridine | 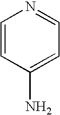 |

c) Additives

Antioxidant Irganox® 245 from Ciba, a compound of the formula

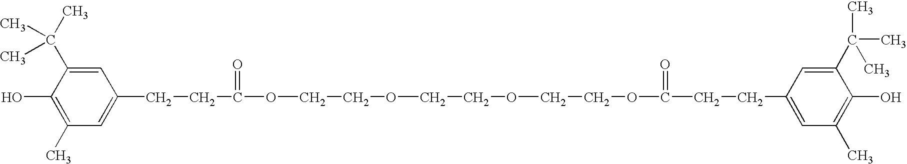

d) Preparation, According to the Invention, of the POM Using Deactivators D

A monomer mixture consisting of 96.995% by weight of trioxane, 3% by weight of dioxolane and 0.005% by weight of methylal was metered continuously into a polymerization reactor at a flow rate of 5 kg/h. The reactor was a tubular reactor provided with static mixers and was operated at 150° C. and 30 bar.

0.1 ppmw of perchloric acid was metered as an initiator into the monomer stream, for which purpose a 0.01% strength by weight solution of 70% strength by weight aqueous perchloric acid in gamma-butyrolactone was used. After a polymerization time (residence time) of 2 min, the deactivator D (cf. table) was metered as a 0.1% strength by weight solution in 1,3-dioxolane into the polymer melt and mixed in so that the deactivator was present in a 10-fold molar excess of the piperidine end groups (D1 to D3) or imidazole end groups (D4) relative to the initiator. The residence time in the deactivation zone was 3 min.

The polymer melt was taken off through a pipeline and let down via a control valve into a first flash pot which was provided with a waste gas pipe. The temperature of the flash pot was 190° C. and the pressure was 3.5 bar.

The vapors were taken off from the first flash pot through the waste gas pipe and fed into a falling-film condenser and brought into contact there at 118° C. and 3.5 bar with a feed comprising fresh trioxane. Parts of the vapor were precipitated here in the fresh trioxane; the mixture obtained was then fed to the polymerization reactor. The vapor not precipitated in the fresh trioxane was fed through a pressure control valve which regulated the pressure in the falling-film condenser to a waste gas pipe.

The polymer melt was taken off from the first flash pot through a pipeline and let down via a control valve into a second flash pot which was provided with a waste gas line (not leading to the falling-film condenser). The temperature of the second flash pot was 190° C. and the pressure was ambient pressure. The pot had no base and was mounted directly on the feed dome of a ZSK 30 twin-screw extruder from Werner & Pfleiderer, so that the devolatilized polymer from the pot fell directly onto the extruder screws.

The extruder was operated at 190° C. and at a screw speed of 150 rpm and was provided with vents which were operated at 250 mbar. Moreover, it had a feed orifice for additives, through which 0.5 kg/h of the antioxidant Irganox® 245 was metered. The product was discharged, cooled and granulated in a customary manner.

The melt volume rate (MVR) according to ISO 1133 at a melting point of 190° C. and a nominal load of 2.16 kg was determined for the granules obtained.

e) Preparation, Not According to the Invention, of the POM Using Comparative Compounds C

The procedure was as described under d), except that, instead of the deactivator D, the comparative deactivators C (cf. table) as a 0.1% strength by weight solution in 1,3-dioxolane were metered into the polymer melt and mixed in so that the compound C was present in a 10-fold molar excess relative to the initiator.

When the vapor from the first flash pot came into contact with the trioxane feed in the falling-film condenser and this mixture was fed to the polymerization reactor, the reaction stopped. It was not possible to obtain product which could be granulated.

Table 2 summarizes the results.

TABLE 2
Results of the polymerization (C for comparison)

| | | Melt volume rate MVR |
|---|---|---|
| Example | Deactivator | (190° C., 2.16 kg) [cm³/10 min] |
| 1 | D1 | 18.5 |
| 2 | D2 | 17 |
| 3 | D3 | 16 |
| 4 | D4 | 7 |
| 5C | C1 | no product obtained |
| 6C | C2 | no product obtained |
| 7C | C3 | no product obtained |
| 8C | C4 | no product obtained |

The results of examples 1 to 4 show that, with the process according to the invention, polyoxymethylene could be prepared in a simple manner. The residual monomers separated off were recycled directly to the polymerization without purification, without any adverse effects occurring. The deactivators did not interfere with the polymerization.

When monomeric compounds C having a piperidine or pyridine structure were used not according to the invention (examples 5C to 8C), the polymerization reaction immediately stopped. It is presumed that the compounds C were present as an impurity in the residual monomers separated off and recycled.

1. A process for the preparation of polyoxymethylene homo- or copolymers (POM) by polymerization of suitable monomers and subsequent deactivation by addition of a deactivator, wherein the deactivator used is a highly branched or hyperbranched polymer A) which is selected from highly branched or hyperbranched polycarbonates A1) and highly branched or hyperbranched polyesters A2), the polymer A) comprising nitrogen atoms.

2. The process according to claim 1, wherein the highly branched or hyperbranched polycarbonate A1) has an OH number of from 0 to 600 mg KOH/g of polycarbonate (according to DIN 53240, part 2).

3. The process according to claim 1, wherein the highly branched or hyperbranched polyester A2) is of the type AₓB_{y}, x being at least 1.1 and y being at least 2.1.

4. The process according to claim 1, wherein the polymer A is obtainable by polymerizing suitable monomers to give the polymer A) and concomitantly using a nitrogen-containing compound.

5. The process according to claim 1, wherein the polymer A) is obtainable by first polymerizing suitable monomers to give a precursor polymer A*) and then reacting this precursor polymer A*) with a nitrogen-containing compound to give the polymer A).

6. The process according to claim 1, wherein the nitrogen-containing compound is an amine.

7. The process according to claim 1, wherein the amine is selected from
i) sterically hindered amines i),
ii) aromatic amines ii) whose amino group is bonded directly to the aromatic system, and
iii) imidazoles iii).

8. The process according to claim 1, wherein the stearically hindered amine i) is an amine based on 2,2,6,6-tetramethylpiperidine.

9. The process according to claim 1, wherein the polymer A) is a highly branched or hyperbranched polycarbonate A1) in whose preparation 1,2,2,6,6-pentamethylpiperidin-4-ol or 2,2,6,6-tetramethylpiperidin-4-ol or a mixture thereof is concomitantly used.

10. The process according to claim 1, wherein the imidazole iii) is an aminoalkylimidazole.

11. The process according to claim 1, wherein the polymer A) is a highly branched or hyperbranched polycarbonate A1) in whose preparation 1-(3-aminopropyl)imidazole was concomitantly used.

12-15. (canceled)

16. The process according to claim 2, wherein the polymer A is obtainable by polymerizing suitable monomers to give the polymer A) and concomitantly using a nitrogen-containing compound.

17. The process according to claim 3, wherein the polymer A is obtainable by polymerizing suitable monomers to give the polymer A) and concomitantly using a nitrogen-containing compound.

18. The process according to claim 2, wherein the polymer A) is obtainable by first polymerizing suitable monomers to give a precursor polymer A*) and then reacting this precursor polymer A*) with a nitrogen-containing compound to give the polymer A).

19. The process according to claim 3, wherein the polymer A) is obtainable by first polymerizing suitable monomers to give a precursor polymer A*) and then reacting this precursor polymer A*) with a nitrogen-containing compound to give the polymer A).

20. The process according to claim 2, wherein the nitrogen-containing compound is an amine.

21. The process according to claim 3, wherein the nitrogen-containing compound is an amine.

22. The process according to claim 4, wherein the nitrogen-containing compound is an amine.

23. The process according to claim 5, wherein the nitrogen-containing compound is an amine.

24. The process according to claim 2, wherein the amine is selected from
i) sterically hindered amines i),
ii) aromatic amines ii) whose amino group is bonded directly to the aromatic system, and
iii) imidazoles iii).
